(19) United States
(12) Patent Application Publication
(10) Pub. No.: US 2025/0364589 A1
(43) Pub. Date: Nov. 27, 2025

(54) Li-CONDUCTOR PROTOTYPES IN THE Li-La-B-O CHEMICAL SPACE FOR ALL-SOLID-STATE BATTERIES

(71) Applicant: SAMSUNG ELECTRONICS CO., LTD., Suwon-si (KR)

(72) Inventors: Mahdi AMACHRAA, Cambridge, MA (US); Yan WANG, Brookline, MA (US)

(73) Assignee: SAMSUNG ELECTRONICS CO., LTD., Suwon-si (KR)

(21) Appl. No.: 18/830,070

(22) Filed: Sep. 10, 2024

Related U.S. Application Data
(60) Provisional application No. 63/650,619, filed on May 22, 2024.

(51) Int. Cl. H01M 10/0562; H01M 4/02; H01M 4/13; H01M 10/0525

(52) U.S. Cl. CPC H01M 10/0562; H01M 4/13; H01M 10/0525; H01M 2004/027; H01M 2004/028; H01M 2300/0071

(57) ABSTRACT

A lithium-containing oxide has one of the following parent compositions: Li3-zLa(BO3)2, Li6-zLa(BO3)3, where z ranges from −0.5 to 0.5. A lithium solid-state battery includes an anode, a cathode, and a solid electrolyte, wherein the solid electrolyte includes the aforementioned lithium-containing oxide. Also, a solid-state battery includes an anode, a cathode, and a solid electrolyte, wherein at least one of the anode and the cathode is coated with a coating which includes the aforementioned lithium-containing oxide.

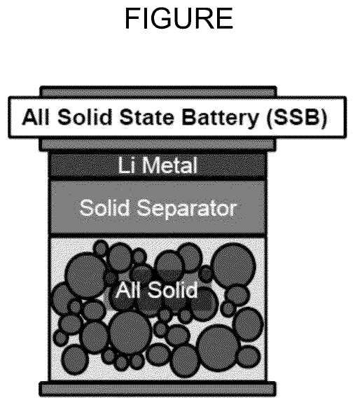

### CROSS-REFERENCE TO RELATED APPLICATION

This application is based on and claims priority from U.S. Provisional Application No. 63/650,619 filed on May 22, 2024 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and/or for use as electrode coatings for solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. An all solid state battery is shown in the FIGURE. In the FIGURE, the all solid component can comprise solid cathode particles in a solid catholyte, and the solid separator can comprise a solid electrolyte.

Solid-state lithium-ion conductors with high ionic conductivities play an important role in SSBs. During the past two decades, there has been an increasing amount of work on new solid-state lithium-ion conductors (SSLICs). And most of them are focused on sulfide SSLICs with high ionic conductivities. However, very limited number of oxide materials were developed for SSBs, and so far only lithium garnet is considered to be the oxide-type electrolyte for lithium SSBs.

For solid-state electrolytes in SSBs, sulfide-based materials have high ionic conductivities (>10 mS/cm) but not really safe (H2S in air condition) and have limited electrochemical stability (for example, unstable against Li metal).

Oxide SSLICs, which own better electrochemical and chemical stability than sulfide SSLICs, have been largely limited in garnet-type materials. The ionic conductivities of reported oxide SSLICs are generally lower than those of sulfide SSLICs.

Solid state electrolyte materials with superionic conductivity and interfacial stability are desirable materials to form all-solid-state Li-metal batteries. However, several problems and challenges are currently being investigated, such as achieving high ionic conductivity at room temperature, ensuring good interfaces between solid-state electrolytes and electrode materials, developing cost-effective solid-state-electrolytes that can compete with currently established liquid electrolyte technologies is also a hurdle for widespread adoption. Currently, very few Li-oxide conductors have been uncovered. Consequently, discovering new compositions within the Li—La—B—O chemical space is a promising venture to uncover simple, cost-effective, high stability Li-conductors.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—La—B—O chemical space by applying a machine learning-based crystal structure prediction algorithm.

In this disclosure, novel lithium-containing oxides include the following parent compositions: Li3-zLa(BO3)2, Li6-zLa(BO3)3, where z ranges from −0.5 to 0.5.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

A first embodiment of the present disclosure provides a lithium-containing oxide of one of the following parent compositions: Li3-zLa(BO3)2, Li6-zLa(BO3)3, where z ranges from −0.5 to 0.5.

A second embodiment of the present disclosure provides a lithium-containing oxide of the first embodiment, wherein the lithium-containing oxide is a lithium-containing oxide of the parent composition Li3-zLa(BO3)2, where z ranges from −0.5 to 0.5.

A third embodiment of the present disclosure provides a lithium-containing oxide of the first embodiment, wherein the lithium-containing oxide is a lithium-containing oxide of the parent composition Li6-zLa(BO3)3, where z ranges from −0.5 to 0.5.

A fourth embodiment of the present disclosure provides a lithium-containing oxide of the first embodiment, wherein the lithium-containing oxide is Li3La(BO3)2.

A fifth embodiment of the present disclosure provides a lithium-containing oxide of the first embodiment, wherein the lithium-containing oxide is Li6La(BO3)3.

A sixth embodiment of the present disclosure provides a lithium-containing oxide of the fourth embodiment, wherein the lithium-containing oxide is Li3La(BO3)2 crystallized in space group P2₁/c.

A seventh embodiment of the present disclosure provides a lithium-containing oxide of the fourth embodiment, wherein the lithium-containing oxide is Li3La(BO3)2 crystallized in space group P-1.

An eighth embodiment of the present disclosure provides a lithium solid-state battery comprising an anode, a cathode, and a solid electrolyte, wherein the solid electrolyte comprises the lithium-containing oxide of the first embodiment.

A ninth embodiment of the present disclosure provides a lithium solid-state battery of the eighth embodiment, wherein the solid electrolyte comprises a lithium-containing oxide of the parent composition Li3-zLa(BO3)2, where z ranges from −0.5 to 0.5.

A tenth embodiment of the present disclosure provides a lithium solid-state battery of the eighth embodiment, wherein the solid electrolyte comprises a lithium-containing oxide of the parent composition Li6-zLa(BO3)3, where z ranges from −0.5 to 0.5.

An eleventh embodiment of the present disclosure provides a lithium solid-state battery of the eighth embodiment, wherein the solid electrolyte comprises Li3La(BO3)2.

A twelfth embodiment of the present disclosure provides a lithium solid-state battery of the eighth embodiment, wherein the solid electrolyte comprises Li6La(BO3)3.

A thirteenth embodiment of the present disclosure provides a lithium solid-state battery of the eleventh embodiment, wherein the solid electrolyte comprises Li3La(BO3)2 crystallized in space group P2₁/c.

A fourteenth embodiment of the present disclosure provides a lithium solid-state battery of the eleventh embodiment, wherein the solid electrolyte comprises Li3La(BO3)2 crystallized in space group P-1.

A fifteenth embodiment of the present disclosure provides a lithium solid-state battery comprising an anode, a cathode, and a solid electrolyte, wherein at least one of the anode and the cathode is coated with a coating which comprises the lithium-containing oxide of the first embodiment.

A sixteenth embodiment of the present disclosure provides a lithium solid-state battery of the fifteenth embodiment, wherein the coating comprises a lithium-containing oxide of the parent composition Li3-zLa(BO3)2, where z ranges from −0.5 to 0.5.

A seventeenth embodiment of the present disclosure provides a lithium solid-state battery of the fifteenth embodiment, wherein the coating comprises a lithium-containing oxide of the parent composition Li6-zLa(BO3)3, where z ranges from −0.5 to 0.5.

An eighteenth embodiment of the present disclosure provides a lithium solid-state battery of the fifteenth embodiment, wherein the coating comprises Li3La(BO3)2.

A nineteenth embodiment of the present disclosure provides a lithium solid-state battery of the fifteenth embodiment, wherein the coating comprises Li6La(BO3)3.

A twentieth embodiment of the present disclosure provides a lithium solid-state battery of the fifteenth embodiment, wherein the cathode is coated with the coating which comprises the lithium-containing oxide.

### BRIEF DESCRIPTION OF DRAWINGS

Example embodiments of the present disclosure will be more clearly understood from the following detailed description taken in conjunction with the accompanying drawing in which:

The FIGURE shows an all solid-state battery.

### DETAILED DESCRIPTION OF EXAMPLE EMBODIMENTS

The present disclosure demonstrates several novel compositions within the Li—La—B—O chemical space with Li-ion conductivity.

In this disclosure, novel lithium-containing oxides include the following parent compositions: Li3-zLa(BO3)2, Li6-zLa(BO3)3, where z ranges from −0.5 to 0.5. In this regard, it is noted that there can be lithium deficiency associated with oxygen loss in lithium oxide compounds. A general formula for this disclosure can be, e.g., Li3-zLa(BO3-w)2, where z ranges from −0.5 to 0.5 and w ranges from −0.125 to 0.125, and Li6-zLa(BO3-w)3, where z ranges from −0.5 to 0.5 and w ranges from −0.083 to 0.083. This disclosure also includes the general formula Li3-zLa(BO3-w)2, where z ranges from −0.5 to 0.5 and w ranges from 0 to 0.125, and Li6-zLa(BO3-w)3, where z ranges from −0.5 to 0.5 and w ranges from 0 to 0.083.

In this disclosure, novel Li-ion prototypes within the Li—La—B—O chemical space include the following parent formulas: Li3La(BO3)2, Li6La(BO3)3.

The Li3La(BO3)2 crystallizes in the P2₁/c space group.
The La and Li positions in the P2₁/c phase can occupy a several spatial distributions leading a variety of ways to construct the Li3La(BO3)2 structure under the P2₁/c space group.
Each spatial distribution of La and Li will lead to a different energy above hull, varying from 4.08 me V/atom to 58.10 me V/atom.
The Li sites can occupy a tetrahedron, square-plane, triangular non-coplanar, trigonal bipyramid and T-shaped polyhedron geometries. While the La sites can occupy a dodecahedron, octahedron, trigonal bipyramid, or a square-face bicapped trigonal prism.
The Li activation energy (3-dimensional) in this phase varies from 0.61 eV to 1.30 eV, depending on the Li/La spatial distribution within the compound.
The reduction potential against Li is 0.78 V, while the oxidation potential is 3.41 V, suggesting that this material can be used as anolyte against an alloy anode or graphite anode (in batteries, these materials as solid-state electrolyte can form solid-electrolyte interphases by chemical-reaction with electrodes and widen the redox potential window of the electrolytes).
The reaction energy between Li3La(BO3)2 and water is 0 eV/atom suggesting a high aqueous stability for this compound.

The Li6La(BO3)3 crystallizes in the P2₁/c space group.
The energy above hull of 9.6 meV/atom.
The Li activation energy is 0.5 eV (1-dimensional), 0.55 eV (2-dimensional), 0.98 eV (3-dimensional).
The reduction potential against Li is 0.78 V, while the oxidation potential is 3.41 V, suggesting that this material can be used as anolyte against an alloy anode or graphite anode.
The reaction energy between Li6La(BO3)3 and water is 0 eV/atom suggesting a high aqueous stability for this compound.

High-throughput data-mining was conducted to derive novel prototype Li-containing structures, and advanced data analytics was performed to extract novel Li-ion conductors that are stable against Li metal, stable anolyte against various types of anodes such as alloy anode or graphite anode, stable catholytes and stable coating materials in solid state batteries.

The lithium-containing oxides in this disclosure can be made by a standard solid-state method. In this method, precursor powders are combined in a certain ratio depending on the composition of the target material. As one example, precursors may consist of lithium carbonate (Li₂CO₃), lanthanum oxide (La₂O₃), and boric oxide (B₂O₃), and as another example, precursors may consist of lithium oxide (Li₂O), lanthanum oxide, and boric oxide.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature (e.g., 500-1000° C.) for an appropriate period of time (e.g., 6-12 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., 6-12 hours) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

### EXAMPLES

Embodiments will now be illustrated by way of the following examples, which do not limit the embodiments in any way.

A machine learning-based crystal structure prediction algorithm was applied to obtain the following compositions as set forth in Table 1.

TABLE 1

| | | | | | | | | | H2O | | | |
|---|---|---|---|---|---|---|---|---|---|---|---|---|
| Host | | Chemical | Mobile | | | | | | RxN | H2O | | |
| ID | Formula | Space | Ion | E_1D | E_2D | E_3D | Vred | Vox | Energy | Content | Ehull | SPG |
| 36261 | Li3La(BO3)2 | B—La—Li—O | Li1+ | 0.68 | 0.69 | 0.76 | 0.78 | 3.41 | 0.0 | 1.0 | 58.1 | P2₁/c |
| 36405 | Li3La(BO3)2 | B—La—Li—O | Li1+ | 0.62 | 0.69 | 1.71 | 0.78 | 3.41 | 0.0 | 1.0 | 55.83 | P-1 |
| 36467 | Li3La(BO3)2 | B—La—Li—O | Li1+ | 0.49 | 0.49 | 0.61 | 0.78 | 3.41 | 0.0 | 1.0 | 37.06 | P2₁/c |
| 36792 | Li3La(BO3)2 | B—La—Li—O | Li1+ | 0.51 | 0.6 | 0.61 | 0.78 | 3.41 | 0.0 | 1.0 | 40.85 | P2₁/c |
| 36973 | Li3La(BO3)2 | B—La—Li—O | Li1+ | 0.62 | 0.62 | 1.3 | 0.78 | 3.41 | 0.0 | 1.0 | 4.08 | P2₁/c |
| 36978 | Li3La(BO3)2 | B—La—Li—O | Li1+ | 0.43 | 0.44 | 2.27 | 0.78 | 3.41 | 0.0 | 1.0 | 42.25 | P-1 |
| 37057 | Li3La(BO3)2 | B—La—Li—O | Li1+ | 0.47 | 0.63 | 1.67 | 0.78 | 3.41 | 0.0 | 1.0 | 54.48 | P-1 |
| 36717 | Li6La(BO3)3 | B—La—Li—O | Li1+ | 0.5 | 0.55 | 0.98 | 0.78 | 3.41 | 0.0 | 0.0 | 9.65 | P2₁/c |

As can be seen from the results presented in Table 1, the 0.78 V reduction potential against Li and the 3.41 V oxidation potential for the Li3La(BO3)2 composition suggest that the composition can be used as anolyte against an alloy anode or graphite anode (again, in batteries, these materials as solid-state electrolyte can form solid-electrolyte interphases by chemical reaction with electrodes and widen the redox potential window of the electrolytes; this applies to the materials below as well), and the reaction energy between Li3La(BO3)2 and H2O is 0 eV/atom, suggesting a high aqueous stability for this compound. Also, the 0.78 V reduction potential against Li and the 3.41 V oxidation potential for the Li6La(BO3)3 composition suggest that this material can be used as anolyte against an alloy anode or graphite anode, and the reaction energy between the Li6La(BO3)3 composition and H2O is 0 eV/atom, suggesting a high aqueous stability for this compound.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium-containing oxide of one of the following parent compositions: 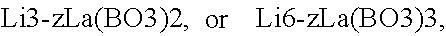
where z ranges from −0.5 to 0.5.

2. The lithium-containing oxide of claim 1, wherein the lithium-containing oxide is a lithium-containing oxide of the parent composition Li3-zLa(BO3)2, where z ranges from −0.5 to 0.5.

3. The lithium-containing oxide of claim 1, wherein the lithium-containing oxide is a lithium-containing oxide of the parent composition Li6-zLa(BO3)3, where z ranges from −0.5 to 0.5.

4. The lithium-containing oxide of claim 1, wherein the lithium-containing oxide is Li3La(BO3)2.

5. The lithium-containing oxide of claim 1, wherein the lithium-containing oxide is Li6La(BO3)3.

6. The lithium-containing oxide of claim 4, wherein the lithium-containing oxide is Li3La(BO3)2 crystallized in space group P2₁/c.

7. The lithium-containing oxide of claim 4, wherein the lithium-containing oxide is Li3La(BO3)2 crystallized in space group P-1.

8. A lithium solid-state battery comprising an anode, a cathode, and a solid electrolyte, wherein the solid electrolyte comprises the lithium-containing oxide of claim 1.

9. The lithium solid-state battery of claim 8, wherein the solid electrolyte comprises a lithium-containing oxide of the parent composition Li3-zLa(BO3)2, where z ranges from −0.5 to 0.5.

10. The lithium solid-state battery of claim 8, wherein the solid electrolyte comprises a lithium-containing oxide of the parent composition Li6-zLa(BO3)3, where z ranges from −0.5 to 0.5.

11. The lithium solid-state battery of claim 8, wherein the solid electrolyte comprises Li3La(BO3)2.

12. The lithium solid-state battery of claim 8, wherein the solid electrolyte comprises Li6La(BO3)3.

13. The lithium solid-state battery of claim 11, wherein the solid electrolyte comprises Li3La(BO3)2 crystallized in space group P2₁/c.

14. The lithium solid-state battery of claim 11, wherein the solid electrolyte comprises Li3La(BO3)2 crystallized in space group P-1.

15. A lithium solid-state battery comprising an anode, a cathode, and a solid electrolyte, wherein at least one of the anode and the cathode is coated with a coating which comprises the lithium-containing oxide of claim 1.

16. The lithium solid-state battery of claim 15, wherein the coating comprises a lithium-containing oxide of the parent composition Li3-zLa(BO3)2, where z ranges from −0.5 to 0.5.

17. The lithium solid-state battery of claim 15, wherein the coating comprises a lithium-containing oxide of the parent composition Li6-zLa(BO3)3, where z ranges from −0.5 to 0.5.

18. The lithium solid-state battery of claim 15, wherein the coating comprises Li3La(BO3)2.

19. The lithium solid-state battery of claim 15, wherein the coating comprises Li6La(BO3)3.

20. The lithium solid-state battery of claim 15, wherein the cathode is coated with the coating which comprises the lithium-containing oxide.
